(19) United States
(12) Patent Application Publication
(10) Pub. No.: US 2020/0079581 A1
(43) Pub. Date: Mar. 12, 2020

(54) INTERLEAVE FOR FOOD SLICES

(71) Applicant: Sargento Foods Inc., Plymouth, WI (US)

(72) Inventors: Jeff Karp, Elkhart Lake, WI (US); Todd Purkey, Elkhart Lake, WI (US)

(21) Appl. No.: 16/124,612

(22) Filed: Sep. 7, 2018

(51) Int. Cl. B65D 85/76; B65D 75/20; B65D 75/52; A23C 19/09; A23C 19/16; B65B 25/06; B65B 25/08; B65D 75/00

(52) U.S. Cl. CPC B65D 85/76; B65D 75/20; B65D 75/52; B65D 75/002; A23C 19/166; B65B 25/068; B65B 25/08; A23C 19/0908

(57) ABSTRACT

A cheese package has at least three individual slices of cheese in a stack. The cheese package includes a separator between each adjacent pair of slices such that adjacent slices do not contact one another. Each separator has a body and a tab extending beyond the stack, the body having sufficient rigidity for a user to lift any one of the separators using the tab from the stack to remove at least one slice while maintaining the integrity of the removed at least one slice. The cheese package also includes packaging surrounding the stack.

### BACKGROUND

The present invention relates to an interleave for a food slice.

Interleaves generally include thin parchment paper separating individual slices of food. For example, packaged cheese slices are separated by parchment paper. The use of parchment paper provides little to no rigidity for lifting and handling a slice of food, resulting in potential tearing of the food as the food and parchment paper are lifted. The parchment paper and food slice also tend to bend under gravity when lifted from the adjacent slices, which may cause cracking and breakage in the food slice. The types of food that may be resistant to unacceptable amounts of tearing and breakage are limited. Also, in order to get between slices to initiate lifting, a user often must touch adjacent slices of food.

### SUMMARY

In one aspect, the invention provides a cheese package having at least three individual slices of cheese in a stack. The cheese package includes a separator between each adjacent pair of slices such that adjacent slices do not contact one another. Each separator has a body and a tab extending beyond the stack, the body having sufficient rigidity for a user to lift any one of the separators using the tab from the stack to remove at least one slice while maintaining the integrity of the removed at least one slice. The cheese package also includes packaging surrounding the stack.

In another aspect, the invention provides a food stacking system including at least three pieces of food in a stack. The food stacking system also includes a separator between each adjacent pair of pieces such that the adjacent pieces do not contact one another. Each separator has a body and a tab extending beyond the stack, the body having sufficient rigidity for a user to lift any one of the separators using the tab from the stack to remove at least one piece while maintaining the integrity of the at least one removed piece.

In yet another aspect, the invention provides a method for packaging cheese slices including creating a stack of alternating cheese slices and separators, the separators being dimensioned so that adjacent cheese slices are not in contact with one another, the separators having a body and having a tab extending beyond the stack of cheese slices, the body having sufficient rigidity for a user to lift any one of the separators using the tab from the stack to remove a slice while maintaining the integrity of the removed slice. The method also includes surrounding the stack with packaging.

Other aspects of the invention will become apparent by consideration of the detailed description and accompanying drawings.

### BRIEF DESCRIPTION OF THE DRAWINGS

FIG. 1 is a perspective view of a separator.

FIG. 2 is a top view of the separator.

FIG. 3 is a perspective view of the separator adjacent a slice of food.

FIG. 4 is a top view of the separator adjacent the slice of food.

FIG. 5 is a side view of the separator adjacent the slice of food.

FIG. 6 is a cross-section view of the separator adjacent the slice of food, such as cheese.

FIG. 7 is a perspective view of a straight stack.

FIG. 8 is a top view of the straight stack.

FIG. 9 is a side view of the straight stack.

FIG. 10 is a perspective view of the straight stack in a packaging.

FIG. 11 is a perspective view of another construction of the straight stack.

FIG. 12 is a top view of another construction of the straight stack.

FIG. 13 is side view of another construction of the straight stack.

FIG. 14 is a perspective view of a stagger stack.

FIG. 15 is a top view of the stagger stack.

FIG. 16 is a side view of the stagger stack.

FIG. 17 is a perspective view of a shingle stack.

FIG. 18 is a side view of the shingle stack.

FIG. 19 is a perspective view of the shingle stack in a packaging.

FIG. 20 is a perspective view of another construction of the shingle stack.

FIG. 21 is a side view of another construction of the shingle stack.

FIG. 22 is a perspective view of yet another construction of the shingle stack.

FIG. 23 is a side view of yet another construction of the shingle stack.

### DETAILED DESCRIPTION

Before any constructions of the invention are explained in detail, it is to be understood that the invention is not limited in its application to the details of construction and the arrangement of components set forth in the following description or illustrated in the following drawings. The invention is capable of other constructions and of being practiced or of being carried out in various ways.

As used herein, the term “generally” means recognizable to an ordinary observer as embodying the given characteristic or approximately the given characteristic. For example, one may not be hindered from making an identification of a certain characteristic, such as square, even though all the sides are not necessarily exactly equal, exactly straight, or exactly at right angles, etc. As such, “generally square” means recognizable to one of ordinary skill as being square or approximately square. The same definition applies to other characteristics preceded by the word “generally” herein.

As used herein, the term “about” means within manufacturing tolerances of the given dimension as would be understood by one of ordinary skill in the art.

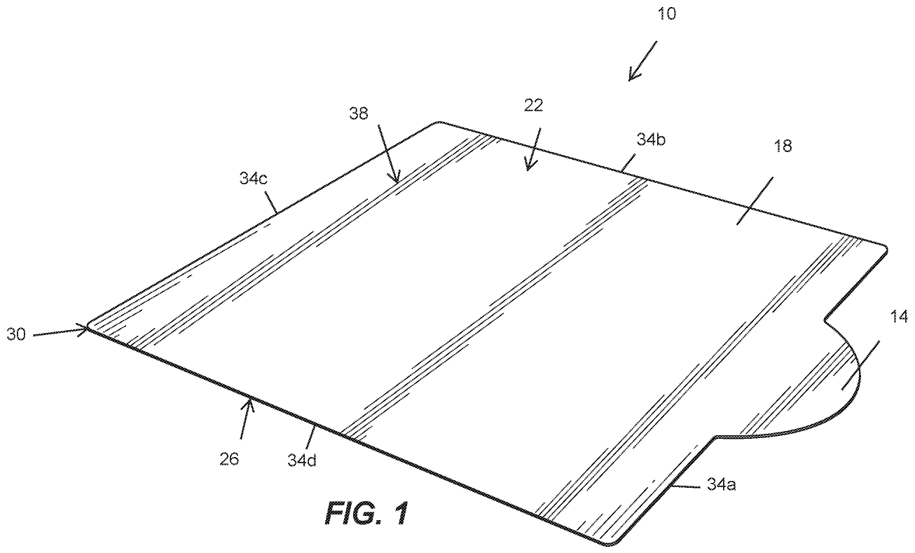

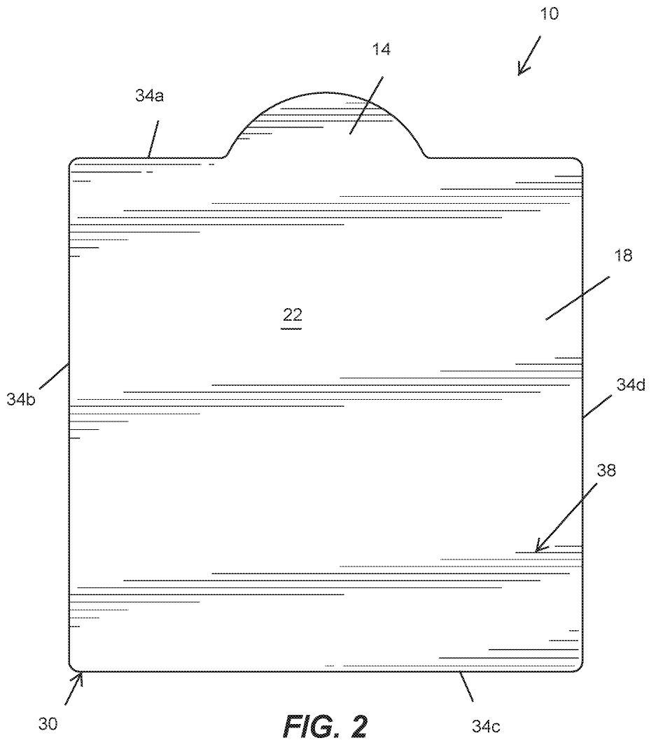

FIGS. 1-2 illustrate a separator 10, which may also be referred to as an interleave, having a tab 14 extending from a body 18. In the illustrated construction, the body 18 is generally square and includes a first surface 22 and a second surface 26. The body has a length L and a width W. The length L may be between about 2 inches to about 5 inches; more specifically, the length L may be between about 3 inches to about 4 inches; more specifically, the length L may be between about 3 inches to about 3.5 inches. More specifically, the length L may be about 3¼ inches. The width W may be between about 2 inches to about 5 inches; more specifically the width W may be between about 3 inches to 4 inches; more specifically, the width W may be between about 3.4 inches to about 3.9 inches. More specifically the width W may be about 3 21/32 inches. Generally, the width W is greater than the length L to accommodate for the tab 14 projecting from the body 18, which may be generally square. The body 18 may have sharp or rounded corners. In other constructions, the body 18 may be generally rectangular (which may include generally square). In other constructions, the body 18 may be curved and, more specifically, generally circular, and in other constructions the body 18 may be generally oval, rounded, or any other curved shape. In yet other constructions, the body 18 may be generally triangular or other shapes.

The first surface 22 is generally planar, and the second surface 26 is generally planar and opposite the first surface 22, i.e., facing opposite directions. A side 30 extends between the first surface 22 and the second surface 26 and may be generally perpendicular to the first surface 22 and the second surface 26. The side 30 may include a plurality of side portions including a first side portion 34a, a second side portion 34b, a third side portion 34c, and a fourth side portion 34d. Each side portion 34a-34d is generally straight, and in other constructions, each side portion 34a-34d may be curved. In other constructions, there may be any number of side portions 34a-34d, such as three side portions. In other constructions, the side 30 may include only one side portion (e.g., when the body is round) and the side portion may be curved, or more specifically may have a cylindrical shape that extends around a perimeter of the first surface 22 and the second surface 26. A coating 38 may be disposed on at least one of the first surface 22 and the second surface 26. In other constructions, the coating 38 may be disposed on the first surface 22 and the second surface 26, and the coating 38 on the first surface 22 may be the same as or different type than the coating 38 on the second surface 26.

The tab 14 is curved and, more specifically, may be generally semi-circular, and in other constructions, the tab 14 may be generally oval, rounded, wavy, or any other curved shape. In yet other constructions, the tab 14 may be generally rectangular, square, triangular, etc., or other shapes and may have sharp or rounded corners. In the illustrated construction, the tab 14 is disposed generally in the middle of one of the side portions 34a-34d of the body 18, such as the first side portion 34a. However, in other constructions the tab 14 may be disposed off-center on one of the side portions 34a-34d of the body 18. The separator 10 is formed from approved direct food contact, rigid or semi-rigid material such as barrier coated paperboard (e.g., wax impregnated paper, fiber impregnated wax, or solid bleached sulfate coated with low-density polyethylene which may be referred to specifically as poly-coated paperboard and may have a size between 14 pt. and 20 pt.) or a rigid or semi-rigid polymer (such as plastic or poly material and more specifically such as polyethylene terephthalate, polystyrene, etc.). Thus, the separator 10 may be formed from polymer and/or paper. In other constructions, the separator 10 may be formed from parchment paper. The body 18 and the tab 14 are formed from the same material and are preferably formed together as a single piece of material. For example, the separator 10 may be cut as a single piece from a sheet of stock material. In other constructions, the body 18 and the tab 14 may be formed from different pieces of material (which may be the same type or different types of material) and joined together.

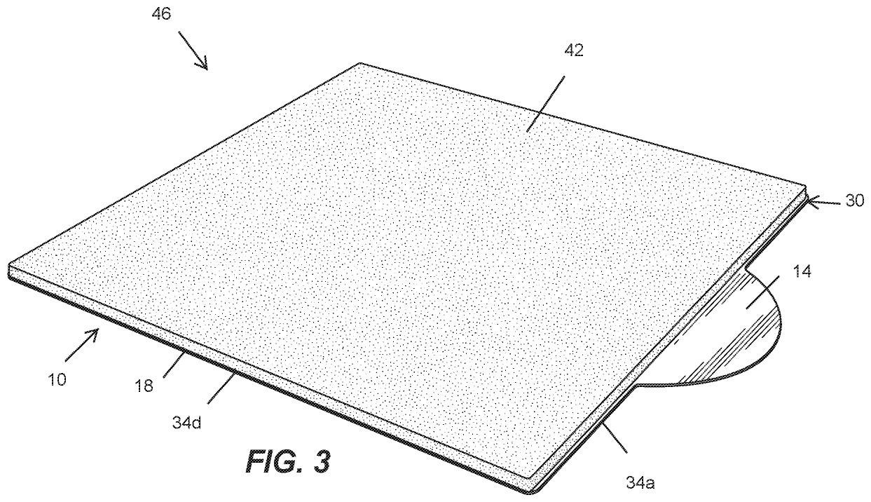

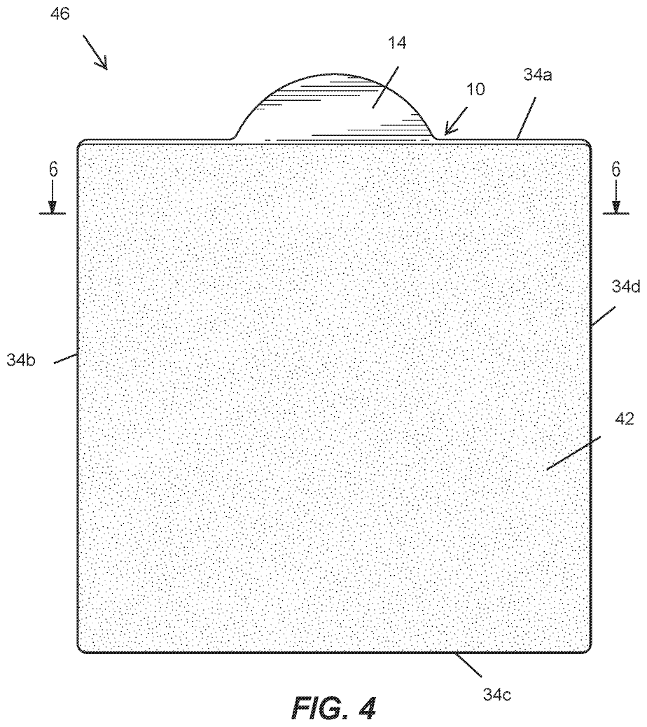

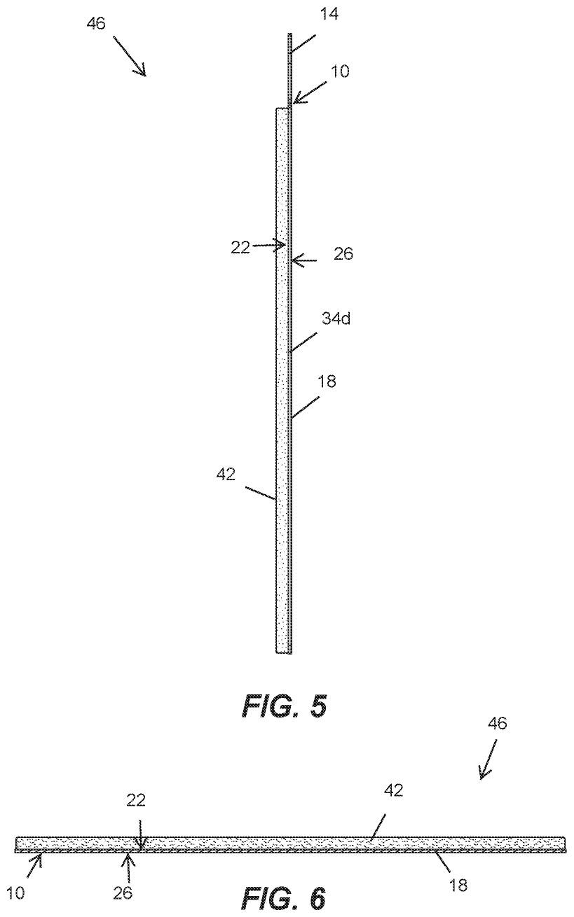

FIGS. 3-6 illustrate the separator 10 adjacent to and directly supporting a piece of food 42, which may be referred to herein as a separator-food pair 46. The piece of food 42 may include a slice of food, and more specifically a slice of cheese as illustrated at least in FIG. 6. In other constructions, the piece of food 42 may include other types of food, such as a slice or other form of meat, bread cracker, etc. The tab 14 of the separator 10 extends beyond the piece of food 42 in order for a user to lift the separator 10 and the piece of food 42 without touching the piece of food 42. In other words, at least a portion of the tab 14 is exposed and is thus not covered by or engaged with the piece of food 42. The piece of food 42 defines a shape which preferably fits within the body 18 without hanging over the side 30. In the illustrated construction, the piece of food 42 has generally the same shape as the body 18, e.g., generally rectangular, generally square, etc. The piece of food 42 may have sharp or rounded corners. In other constructions, the piece of food 42 may be curved and, more specifically generally circular, and in other constructions the piece of food 42 may be generally oval, rounded, or any other curved shape. In yet other constructions, the piece of food 42 may be generally triangular or other shapes. The body 18 has sufficient rigidity for the user to handle and maneuver (e.g. lift) the separator 10 and piece of food 42 using the tab 14 while maintaining the integrity of the piece of food 42 by inhibiting the piece of food 42 from cracking or breaking. The separator 10 and the piece of food 42 supported thereon (i.e., the separator-food pair 46) may be stacked on another separator 10 and another piece of food 42 (i.e., another separator-food pair 46) with each separator 10 being between each adjacent pair of pieces of food 42, as will be described in greater detail below.

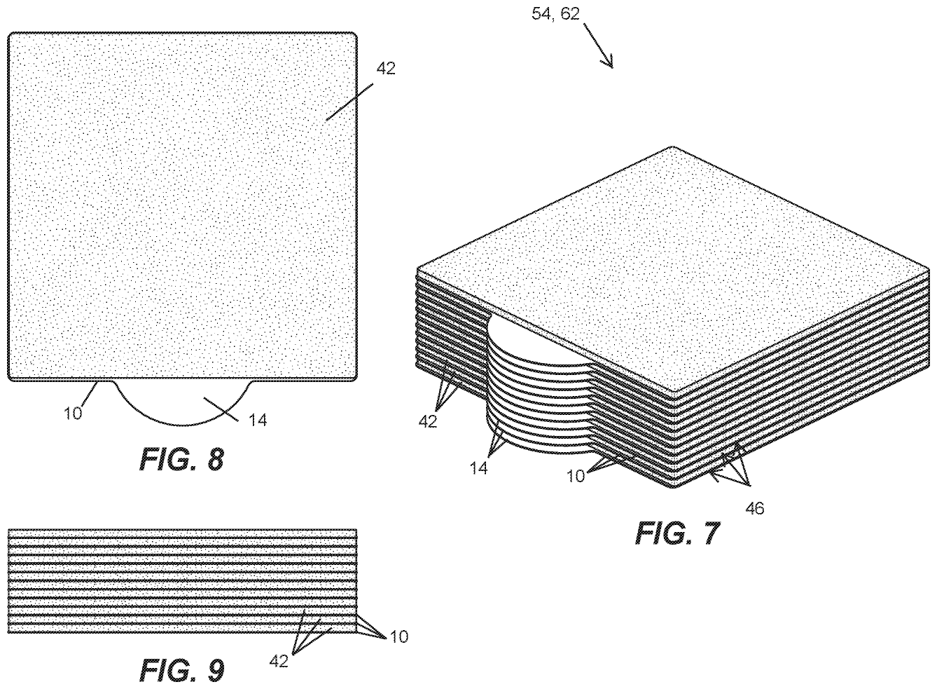

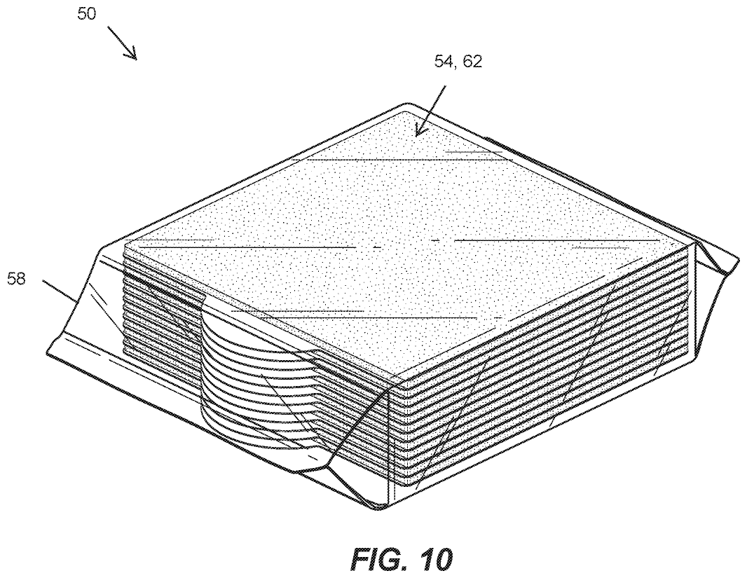

FIGS. 7-10 illustrate a food stacking system 50 (FIG. 10), e.g., a cheese stacking system or a cheese package, including a stack 54 (FIGS. 7-9) and a packaging 58 surrounding the stack 54 (FIG. 10). The stack 54 is a stack of pieces of food 42. In this construction, the stack 54 is a straight stack 62. Specifically, one separator 10 is disposed between each adjacent pair of pieces of food 42 such that the adjacent pieces of food 42 do not contact one another. In other words, the straight stack 62 includes separator-food pairs 46 stacked in a straight line, e.g., coaxially, and more specifically vertically. The pieces of food 42 and separators 10 are disposed such that each piece of food 42 and each body 18 are generally aligned with adjacent pieces of food 42 and adjacent bodies 18, and the tabs 14 (and thus the separators 10 as a whole) are oriented in the same direction relative to the straight stack 62 (i.e., the tabs 14/separators 10 are aligned with each other as shown). Each tab 14 of each separator 10 extends beyond the stack of pieces of food 42 to facilitate lifting without touching the piece of food 42. Each body 18 has sufficient rigidity for a user to lift any one of the separators 10 using the tab 14 to remove at least one piece of food 42 (and the one separator 10 itself) from the stack 54 while maintaining the integrity of the removed at least one piece of food 42 to inhibit the piece of food 42 from cracking or breaking. A plurality of pieces of food 42 in the stack 54 includes at least three individual pieces of food 42. More specifically, the plurality of pieces of food 42 may include at least five individual pieces of food 42, and more specifically may include at least eight individual pieces of food 42, and more specifically may include greater than eight individual pieces of food 42. Each of the pieces of food 42 generally have the same shape, though in other constructions the pieces of food 42 need not have the same shape.

FIG. 10 illustrates the packaging 58 surrounding the stack 54. The packaging 58 may include plastic wrap, flow wrap, vacuum wrap, paper wrap, etc., or other wraps, as well as bags, containers, trays, etc. formed from a polymer and/or a paper product. The packaging 58 generally envelops or surrounds the stack 54 to generally seal the stack 54 from the ambient environment and may be resealable in some constructions (e.g., by way of an adhesive flap or an interlocking groove and ridge, etc., which are not shown in this construction but may be shown in other constructions). The packaging 58 may be clear (as shown) to allow the consumer to view the stack 54, or may be opaque. The packaging 58 may also include indicia (not shown) thereon such as branding, logos, product information, nutrition information, ingredients, etc.

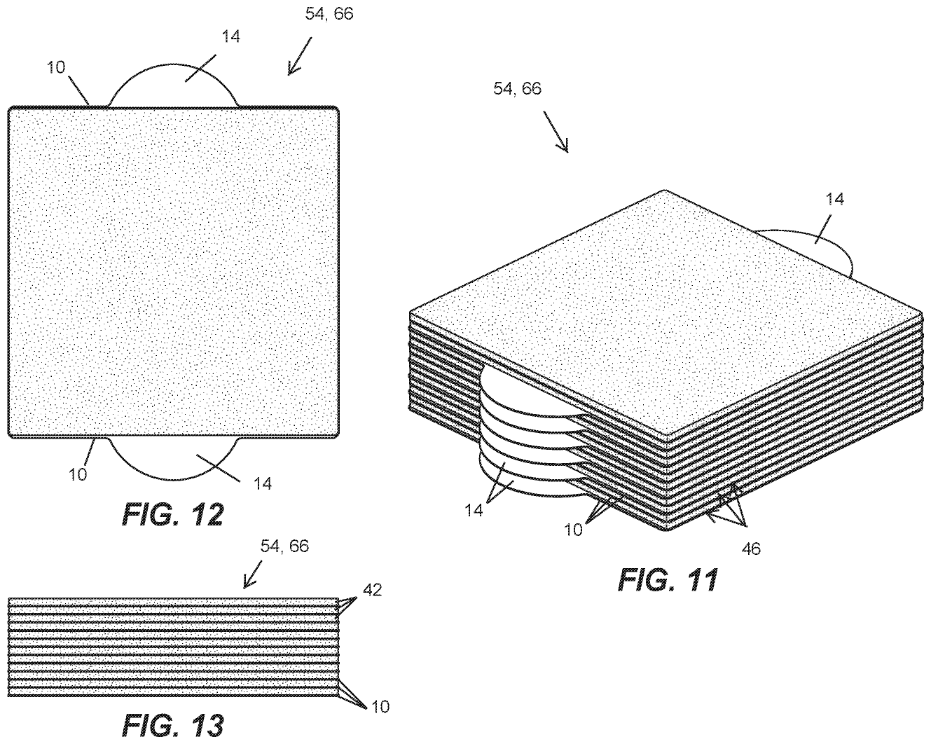

FIGS. 11-13 illustrate another construction of the food stacking system 50 including a stack 54 and the packaging 58 (see FIG. 10) surrounding the stack 54. In this construction, the stack 54 is a straight stack 66 in which the tabs 14 are not all oriented in the same direction relative to the straight stack 66. More specifically, as one example, the tabs 14 may alternate in opposite directions relative to the straight stack 66 of pieces of food 42 as shown. It should be understood that the straight stack 66 may be assembled with the same packaging 58 as described above.

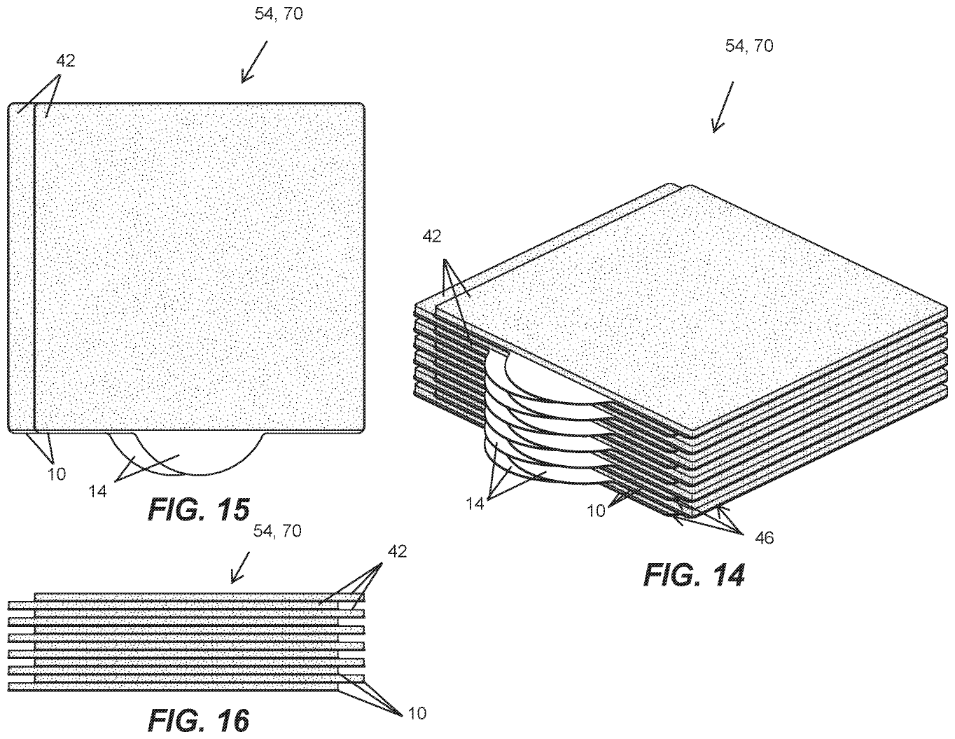

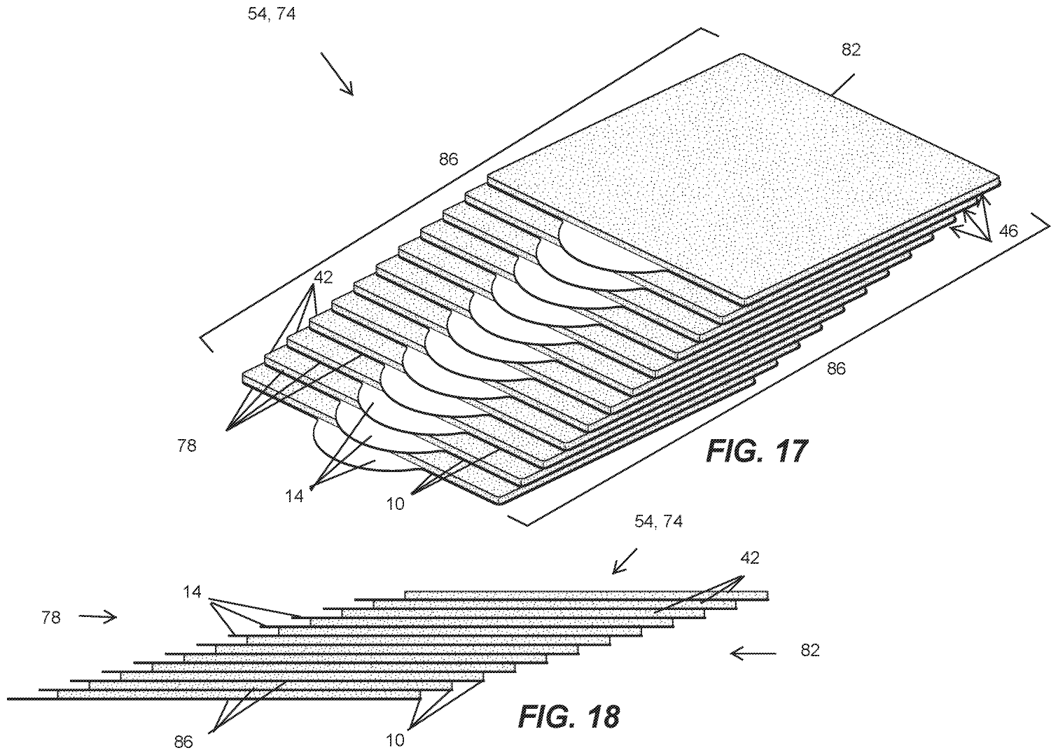

FIGS. 14-16 illustrate another construction of the food stacking system 50 including a stack 54 and the packaging 58 (see FIG. 10) surrounding the stack 54. In this construction, the stack 54 is a stagger stack 70. The stagger stack 70 includes a plurality of pieces of food 42 with one of the separators 10 between each adjacent pair of pieces of food 42 such that the adjacent pieces of food 42 do not contact one another. The pieces of food 42 and separators 10 are disposed so each separator-food pair 46 is generally offset in an alternating fashion from adjacent separator-food pairs 46 (as shown) and the tabs 14 are oriented in the same direction relative to the stagger stack 70 of pieces of food 42. In other words, every other separator-food pair 46 is coaxial. In another construction, the tabs 14 may have a different orientation from one another relative to the stack 70. More specifically, in some constructions, the tabs 14 may extend alternatingly in opposite directions relative to the stagger stack 70. Each tab 14 of each separator 10 extends beyond the stack of pieces of food 42.

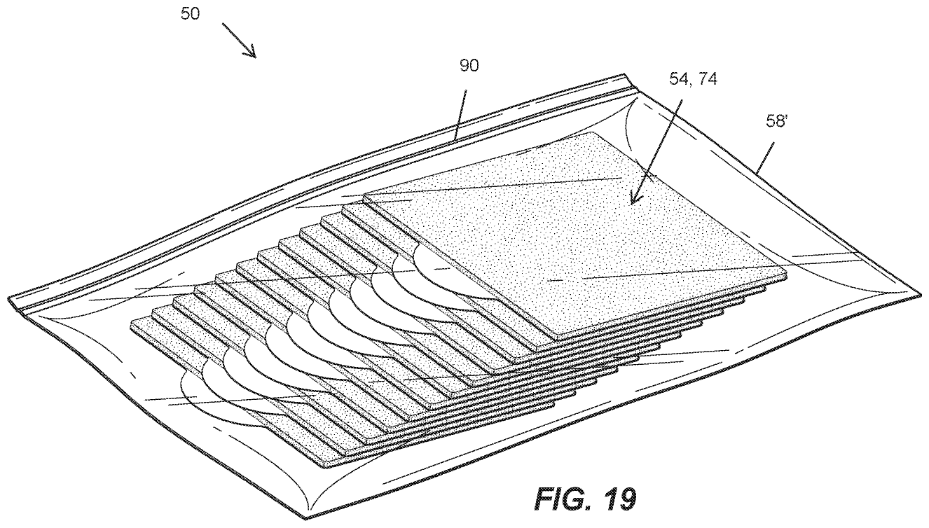

FIGS. 17-19 illustrate yet another construction of the food stacking system 50 (FIG. 19) including a stack 54 (FIGS. 17-18) and a packaging 58 surrounding the stack 54 (FIG. 19). The stack 54, in this construction, is a shingle stack 74. The shingle stack 74 includes a plurality of pieces of food 42 with one of the plurality of separators 10 between each adjacent pair of pieces of food 42 such that the adjacent pieces of food 42 do not contact one another. The separator-food pairs 46 are stacked in a stair-like fashion in which each adjacent separator-food pair 46 is laterally and vertically offset from the previous adjacent separator-food pair 46 in a single continuous direction as shown. The shingle stack 74 includes a leading edge 78, a trailing edge 82, and side edges 86 extending between the leading edge 78 and the trailing edge 82. In the illustrated construction, the tabs 14 of the shingle stack 74 are all oriented in the same direction relative to the shingle stack 74 of pieces of food 42. Specifically, the tabs 14 of the separators 10 extend from the pieces of food 42 of the shingle stack 74 on the leading edge 78. In other constructions, the tabs 14 may have a different orientation from one another relative to the shingle stack 74 of pieces of food 42.

FIG. 19 illustrates another construction of the packaging 58′ surrounding the stack 54. As discussed above, the packaging 58′ may include plastic wrap, flow wrap, vacuum wrap, paper wrap, etc., or other wraps, bags, containers, trays, etc. formed from a polymer and/or a paper product. The packaging 58′ generally envelops or surrounds the stack 54 to generally seal the stack 54 from the ambient environment and may be resealable as illustrated in this construction, e.g., by way of an interlocking groove and ridge 90. However, in other constructions the packaging 58′ may be resealable by any other means, such as an adhesive flap, or need not be resealable. The packaging 58′ may be clear to allow the consumer to view the stack 54, or may be opaque. The packaging 58′ may also include indicia thereon such as branding, logos, product information, nutrition information, ingredients, etc. It should be understood that the packaging 58 and the packaging 58′ may be employed interchangeably with any of the stacks 54 described herein.

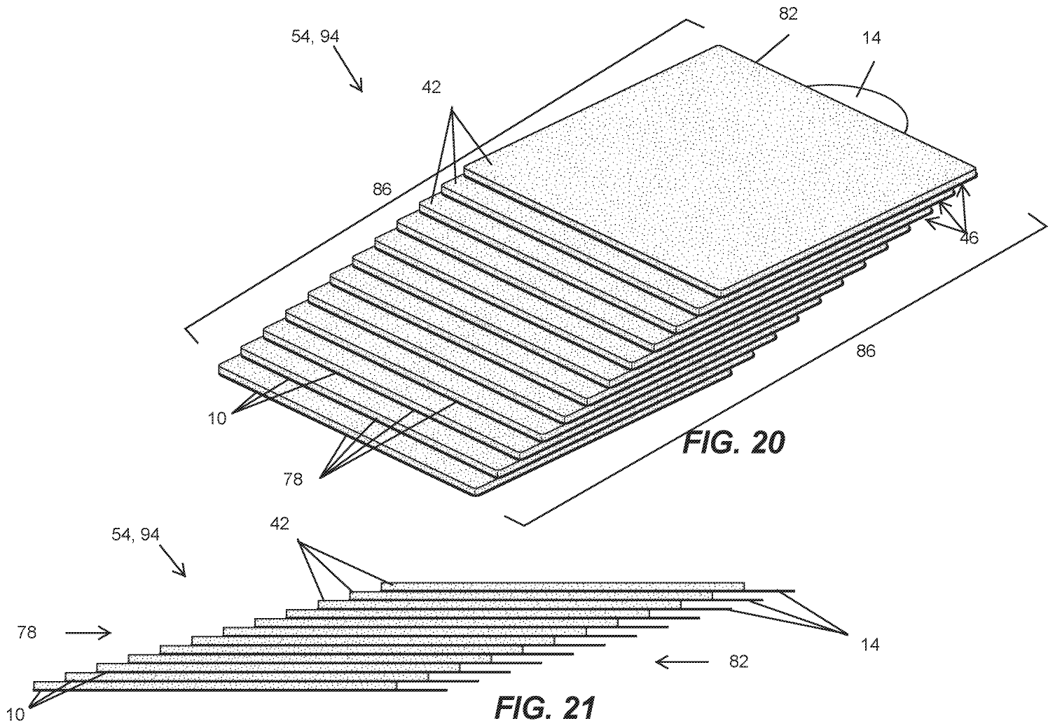

FIGS. 20-21 illustrate another construction of a shingle stack 94 in which the tabs 14 of the separators 10 extend from the shingle stack 94 on the trailing edge 82.

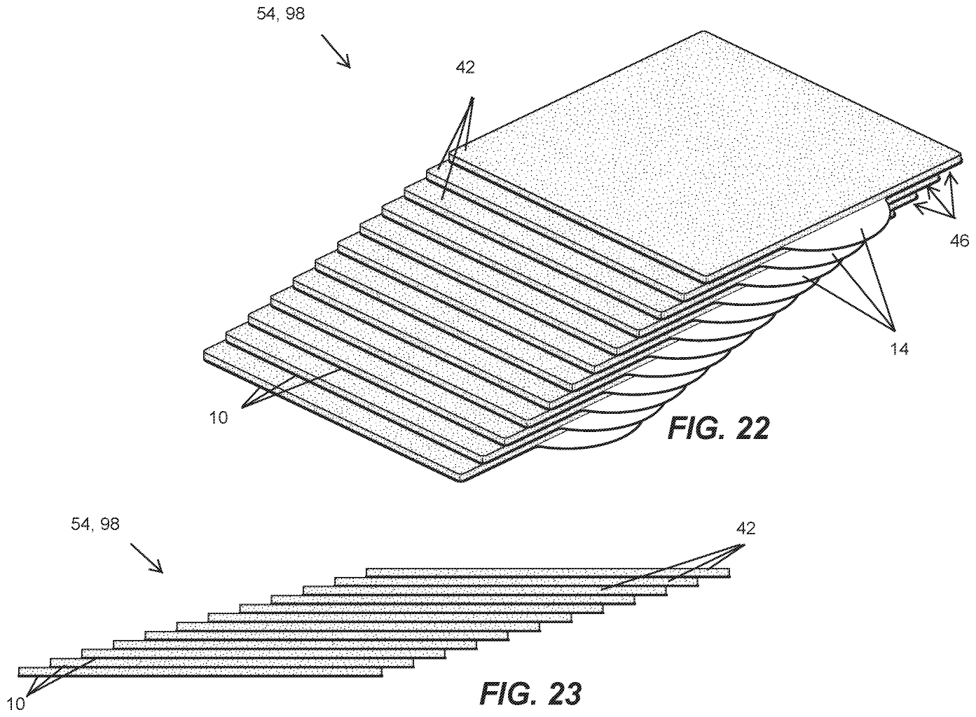

FIGS. 22-23 illustrate another construction of a shingle stack 98 in which the tabs 14 of the separators 10 extend from the shingle stack 98 on one of the side edges 86.

In operation, the separator 10 is formed, preferably from a single piece of material, and the piece of food 42 is placed on the body 18 of the separator 10 with the tab 14 extending beyond the piece of food 42 such that at least a portion of the tab 14 is not in direct contact with the piece of food 42. An operator, or a machine, creates a stack 54 of alternating pieces of food 42 and separators 10. The separators 10 are dimensioned so that adjacent cheese slices in the stack 54 are not in contact with one another. The body 18 has sufficient rigidity for a user to lift a separator 10 using the tab 14 from the stack 54 to remove one of the pieces of food 42 from the stack 54 while maintaining the integrity of the removed slice. The stack 54 is surrounded by a packaging 58 to maintain freshness of the pieces of food 42.

Thus, the invention provides, among other things, a stack 54 of pieces of food 42 having a separator 10 disposed underneath each piece of food 42 to support the respective piece of food 42. Each separator 10 has a tab 14 extending from the stack 54 of pieces of food 42 providing a grip surface that is void of the piece of food 42 so a user can grasp and lift the piece of food 42 by way of the tab 14, as the body 18 supports the piece of food 42, without the need to touch the piece of food 42. The separator 10 also may have sufficient rigidity for a user to lift the separator 10 using the tab 14 from the stack 54 to remove at least one piece of food 42 while maintaining the integrity of the removed at least one piece of food 42. The invention also provides a corresponding method for stacking and/or packaging pieces of food 42. Various features and advantages of the invention are set forth in the following claims.

What is claimed is:

1. A cheese package comprising:
at least three individual slices of cheese in a stack;
a separator between each adjacent pair of slices such that adjacent slices do not contact one another, each separator having a body and having a tab extending beyond the stack, the body having sufficient rigidity for a user to lift any one of the separators using the tab from the stack to remove at least one slice while maintaining the integrity of the removed at least one slice; and
packaging surrounding the stack.

2. The cheese package of claim 1, wherein each slice has a shape and wherein all slices have the same shape.

3. The cheese package of claim 2, wherein the shape is generally square.

4. The cheese package of claim 2, wherein the shape is generally rectangular.

5. The cheese package of claim 1, wherein the at least three individual slices is greater than eight individual slices.

6. The cheese package of claim 1, wherein the stack is a straight stack.

7. The cheese package of claim 1, wherein the stack is a stagger stack.

8. The cheese package of claim 1, wherein the stack is a shingle stack.

9. The cheese package of claim 1, wherein the body and the slice are generally the same shape.

10. The cheese package of claim 1, wherein the tab is generally semi-circular.

11. The cheese package of claim 1, wherein the tab is generally rectangular.

12. The cheese package of claim 1, wherein the tab is positioned generally in the middle of a side of the body.

13. The cheese package of claim 1, wherein the separator is fabricated from one of polymer or paper.

14. The cheese package of claim 1, wherein the body and the tab are fabricated of different materials.

15. The cheese packaging of claim 1, wherein the body has a first and a second surface and wherein there is a coating on at least one of the first and the second surface.

16. The cheese packaging of claim 1, wherein the body has a first and a second surface and wherein there is a coating on the first and the second surface.

17. The cheese packaging of claim 16, wherein the coating on the first surface is different than the coating on the second surface.

18. The cheese package of claim 1, wherein the integrity of the removed slice is maintained without the slice cracking or breaking.

19. The cheese package of claim 6, wherein the separators are all orientated in the same direction relative to the stack.

20. The cheese package of claim 6, wherein the separators are not all orientated in the same direction relative to the stack.

21. The cheese package of claim 7, wherein the separators have a different orientation from one another relative to the stack.

22. The cheese package of claim 8, wherein the separators are all oriented in the same direction relative to the stack.

23. The cheese package of claim 8, wherein the shingle stack has a leading edge, and wherein the tabs of the separators extend from the stack on the leading edge.

24. The cheese package of claim 8, wherein the shingle stack has a trailing edge, and wherein the tabs of the separators extend from the stack on the trailing edge.

25. The cheese package of claim 8, wherein the shingle stack has a side edge, and wherein the tabs of the separators extend from the stack on the side edge.

26. The cheese package of claim 1, wherein the packaging includes at least one of plastic wrap, flow wrap, vacuum wrap and paper wrap.

27. A food stacking system comprising:
at least three pieces of food in a stack; and
a separator between each adjacent pair of pieces such that the adjacent pieces do not contact one another, each separator having a body and having a tab extending beyond the stack, the body having sufficient rigidity for a user to lift any one of the separators using the tab from the stack to remove at least one piece while maintaining the integrity of the at least one removed piece.

28. The food stacking system of claim 27, and further including packaging surrounding the stack.

29. The food stacking system of claim 27, wherein each piece has a shape and wherein all pieces have the same shape.

30. The food stacking system of claim 27, wherein the stack is one of a straight stack, a stagger stack and a shingle stack.

31. The food stacking system of claim 27, wherein the body and the pieces have generally the same shape.

32. The food stacking system of claim 27, wherein the tab is generally semi-circular.

33. The food stacking system of claim 27, wherein the body and the tab are fabricated of the same material.

34. The food stacking system of claim 27, wherein the body has a first and a second surface and wherein there is a coating on at least one of the first and the second surface.

35. The food stacking system of claim 27, wherein the separators are all orientated in the same direction relative to the stack.

36. The food stacking system of claim 28, wherein the packaging includes at least one of plastic wrap, flow wrap, vacuum wrap and paper wrap.

37. A method for packaging cheese slices comprising:
creating a stack of alternating cheese slices and separators, the separators being dimensioned so that adjacent cheese slices are not in contact with one another;
the separators having a body and having a tab extending beyond the stack of cheese slices, the body having sufficient rigidity for a user to lift any one of the separators using the tab from the stack to remove a slice while maintaining the integrity of the removed slice; and
surrounding the stack with packaging.

38. The method for packaging cheese slices of claim 37, wherein the created stack is one of a straight stack, a stagger stack or a shingle stack.

39. The method for packaging cheese slices of claim 37, wherein the separators are all orientated in the same direction relative to the stack.

40. The method for packaging cheese slices of claim 37, wherein the tab is generally semi-circular.

41. The method for packaging cheese slices of claim 37, wherein the packaging is one of plastic wrap, flow wrap, vacuum wrap and paper wrap.
